(19) United States
(12) Patent Application Publication
(10) Pub. No.: US 2022/0014674 A1
(43) Pub. Date: Jan. 13, 2022

(54) IMAGING SYSTEM AND IMAGE PROCESSING APPARATUS

(71) Applicant: KOITO MANUFACTURING CO., LTD., Tokyo (JP)

(72) Inventor: Ryo OTA, Shizuoka-shi (JP)

(73) Assignee: KOITO MANUFACTURING CO., LTD., Tokyo (JP)

(21) Appl. No.: 17/482,653

(22) Filed: Sep. 23, 2021

Related U.S. Application Data
(63) Continuation of application No. PCT/JP2020/013063, filed on Mar. 24, 2020.

(30) Foreign Application Priority Data
Mar. 26, 2019 (JP) 2019-058303
Mar. 26, 2019 (JP) 2019-058304
Mar. 26, 2019 (JP) 2019-058305
Mar. 26, 2019 (JP) 2019-058306

(51) Int. Cl. H04N 5/232; B60R 11/04; G06T 5/00

(52) U.S. Cl. CPC H04N 5/23229; B60R 11/04; G06T 2207/30252; B60R 2300/30; B60R 2300/10; G06T 5/006

(57) ABSTRACT

An imaging system includes a camera and an image processing apparatus. The image processing apparatus tracks an object image included in an output image by the camera, and generates information for correcting distortion of the output image based on a change in shape accompanying movement of the object image. Then, the image processing apparatus corrects the output image using the generated information.

### BACKGROUND

### 1. Technical Field

The present disclosure relates to an imaging system.

### 2. Description of the Related Art

In recent years, cameras have been mounted on automobiles. There are various applications of a camera, such as automatic driving, automatic control of light distribution of a head lamp, a digital mirror, and a front view monitor and a rear view monitor for covering a blind spot.

It is desirable that such a camera can capture an image with as little distortion as possible. However, in many cases, an in-vehicle camera having a wide angle is used, and the influence of distortion appears more remarkably at the outer peripheral portion. Furthermore, even if the distortion of the camera itself is small, in a case where the camera is built in a head lamp, a rear lamp, or the like, distortion is introduced by an additional optical system such as an outer lens.

1. A method is conceivable in which a calibration image such as a grating is captured in a state where a camera is built in an outer lens, and a correction function is determined on the basis of distortion of the grating. In this method, if the design of the outer lens is changed or the positions of the camera and the outer lens are shifted, the correction function becomes useless.

When a camera is used for automatic driving and light distribution control, an image by the camera is input to a discriminator (classifier) on which a prediction model generated by machine learning is mounted, and a position and a type of an object image included in the image by the camera are determined. In this case, when the distortion of the camera is large, it is necessary to use a similarly distorted image as learning data (training data). Therefore, when the design of the outer lens is changed or the positions of the camera and the outer lens are shifted, relearning is required.

### SUMMARY

An aspect of the present disclosure has been made in such a situation, and one exemplary object thereof is to provide an imaging system capable of automatically correcting distortion.

2. When a foreign object such as a raindrop, a snow particle, or mud adheres to the lens of the camera, missing of an image of a region where the foreign object adheres (foreign object region) occurs, which hinders processing using the image by the camera.

An aspect of the present disclosure has been made in such a situation, and one exemplary object thereof is to provide an imaging system that suppresses image quality degradation due to a foreign object.

3. When a water droplet such as a raindrop adheres to a lens of a camera, the water droplet becomes a lens, distortion occurs in an image by the camera, and image quality deteriorates.

An aspect of the present disclosure has been made in such a situation, and one exemplary object thereof is to provide an imaging system that suppresses image quality degradation due to a water droplet.

4. An object identification system that senses a position and a type of an object existing around a vehicle is used for automatic driving and automatic control of light distribution of a headlamp. The object identification system includes a sensor and an operation processing apparatus that analyzes an output of the sensor. The sensor is selected from a camera, light detection and ranging or laser imaging detection and ranging (LiDAR), a millimeter wave radar, an ultrasonic sonar, and the like in consideration of the application, required accuracy, and cost.

The present inventors have studied that a camera as a sensor is built in a headlamp. In this case, there is a possibility that the light emitted from the lamp light source is reflected by the outer lens, enters the image sensor of the camera, and is reflected in the camera image. When the reflection of the lamp light source and the object overlap in the camera image, the identification rate of the object significantly decreases.

As a technique for removing reflection, a method based on machine learning and the like have been proposed, but it is difficult to adopt the technique in an in-vehicle camera having a heavy processing load and requiring real-time performance.

An aspect of the present disclosure has been made in such a situation, and one exemplary object thereof is to provide an imaging system in which an influence of reflection of a lamp light source is reduced.

1. One aspect of the present disclosure relates to an imaging system for a vehicle. The imaging system includes a camera and an image processing apparatus that processes an output image by the camera. The image processing apparatus tracks an object image included in an output image, generates information for correcting distortion of the output image on the basis of a change in shape accompanying movement of the object image, and corrects the output image using the information.

Another aspect of the present disclosure also relates to an imaging system for a vehicle. The imaging system includes a camera and an image processing apparatus that processes an output image by the camera. The image processing apparatus detects a reference object whose true shape is known from the output image, generates information for correcting distortion of the output image on the basis of the true shape and the shape of the image of the reference object in the output image, and corrects the output image using the information.

Still another aspect of the present disclosure relates to an image processing apparatus that is used with a camera and included in an imaging system for a vehicle. The image processing apparatus tracks an object image included in an output image by the camera, generates information for correcting distortion of the output image on the basis of a change in shape accompanying movement of the object image, and corrects the output image using the information.

Still another aspect of the present disclosure is also an image processing apparatus. The image processing apparatus detects a reference object whose true shape is known from the output image by the camera, generates information for correcting distortion of the output image on the basis of the true shape and the shape of the image of the reference object in the output image, and corrects the output image using the information.

2. One aspect of the present disclosure relates to an imaging system for a vehicle. The imaging system includes a camera that generates a camera image at a predetermined frame rate, and an image processing apparatus that processes the camera image. When a foreign object is included in a current frame of the camera image, the image processing apparatus searches the past frame for a background image shielded by the foreign object, and attaches the background image to the foreign object region where the foreign object exists in the current frame.

Another aspect of the present disclosure relates to an image processing apparatus that is used with a camera and included in an imaging system for a vehicle. When a foreign object is included in a current frame of the camera image, the image processing apparatus searches the past frame for a background image shielded by the foreign object, and attaches the background image to the foreign object region where the foreign object exists in the current frame.

3. One aspect of the present disclosure relates to an imaging system for a vehicle. An imaging system includes a camera that generates a camera image, and an image processing apparatus that processes the camera image. When a water droplet is shown in a camera image, the image processing apparatus performs operation of a lens characteristic of the water droplet and corrects an image in a region of the water droplet on the basis of the lens characteristic.

Another aspect of the present disclosure is an image processing apparatus. This device is an image processing apparatus that is used with a camera and included in an imaging system for a vehicle. When a water droplet is captured in a camera image generated by the camera, this device performs operation of a lens characteristic of the water droplet, and corrects an image in a region of the water droplet on the basis of the lens characteristic.

4. One aspect of the present disclosure relates to an imaging system for a vehicle. An imaging system includes a camera that is built in a vehicle lamp together with a lamp light source and generates a camera image at a predetermined frame rate, and an image processing apparatus that processes the camera image. The image processing apparatus extracts a reflection component of the emitted light of the lamp light source on the basis of a plurality of frames, and removes the reflection component from a current frame.

Another aspect of the present disclosure relates to an image processing apparatus. The image processing apparatus is used with a camera, and included in an imaging system for a vehicle. The camera is built in a vehicle lamp together with a lamp light source. The image processing apparatus extracts a reflection component of emitted light of the lamp light source on the basis of a plurality of frames of a camera image generated by the camera, and removes the reflection component from a current frame.

It is to be noted that any arbitrary combination or rearrangement of the above-described structural components and so forth is effective as and encompassed by the present embodiments. Moreover, this summary does not necessarily describe all necessary features so that the disclosure may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram of an imaging system according to Embodiment 1.1;

FIG. 2 is a functional block diagram of an image processing apparatus;

FIG. 3 is a diagram for explaining operation of the imaging system;

FIGS. 4A to 4D are diagrams illustrating a comparison between a shape of an object at a plurality of positions and a true shape of the object;

FIG. 5 is a diagram for explaining tracking in a case where a reference region includes a vanishing point;

FIG. 6 is a block diagram of an imaging system according to Embodiment 1.2;

FIG. 7 is a diagram for explaining operation of the imaging system in FIG. 6;

FIG. 8 is a block diagram of an imaging system according to Embodiment 1.3;

FIG. 9 is a block diagram of an imaging system according to Embodiment 2;

FIG. 10 is a diagram for explaining operation of the imaging system in FIG. 9;

FIGS. 11A and 11B are diagrams for explaining determination of a foreign object region based on edge detection;

FIG. 12 is a diagram for explaining foreign object detection;

FIG. 13 is a diagram for explaining search for a background image;

FIG. 14 is a functional block diagram of an image processing apparatus;

FIG. 15 is a block diagram of an imaging system according to Embodiment 3;

FIG. 16 is a functional block diagram of the image processing apparatus;

FIGS. 17A and 17B are diagrams for explaining estimation of a lens characteristic;

FIGS. 18A to 18C are diagrams for explaining image correction based on lens characteristics;

FIGS. 19A and 19B are diagrams for explaining determination of a water droplet region based on edge detection;

FIG. 20 is a diagram for explaining water droplet detection;

FIG. 21 is a block diagram of an imaging system according to Embodiment 4;

FIG. 22 is a functional block diagram of an image processing apparatus;

FIG. 23 is a diagram for explaining generation of a reflected image based on two frames;

FIG. 24 is a diagram illustrating a reflected image generated from four frames;

FIG. 25 is a diagram illustrating a reflected image generated based on two frames captured in a bright scene;

FIGS. 26A to 26D are diagrams illustrating an effect of removing reflection;

FIGS. 27A to 27D are diagrams for explaining the influence of coefficients in reflection removal;

FIG. 28 is a block diagram of an object identification system including an imaging system; and

FIG. 29 is a block diagram of a display system including an imaging system.

### DETAILED DESCRIPTION

### Embodiment 1.1

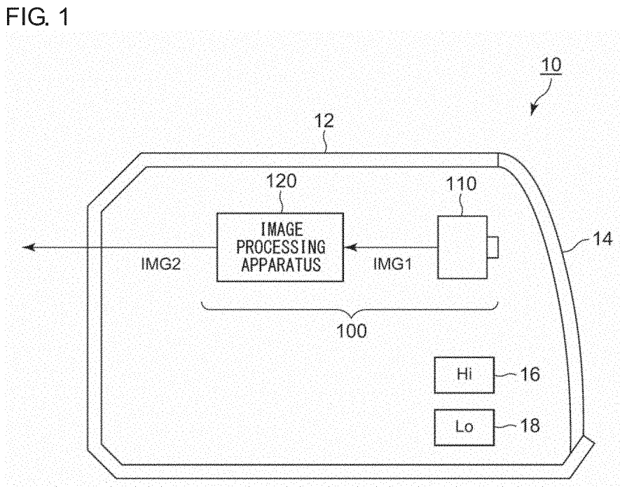

FIG. 1 is a block diagram of an imaging system 100 according to Embodiment 1.1. The imaging system 100 includes a camera 110 and an image processing apparatus 120. The camera 110 is built in a lamp body 12 of a vehicle lamp 10 such as an automobile headlamp. In addition to the camera 110, lamp light sources of a high beam 16 and a low beam 18, lighting circuits thereof, a heat sink, and the like are built in the vehicle lamp 10.

The camera 110 images the front of the camera via an outer lens 14. The outer lens 14 provides additional distortion in addition to the distortion inherent to the camera 110. The type of the camera 110 is not limited, and various cameras such as a visible light camera, an infrared camera, and a TOF camera can be used.

The image processing apparatus 120 generates information (parameters and functions) necessary for correcting distortion including the influence of the camera 110 and the outer lens 14 on the basis of an output image IMG1 of the camera 110. Then, the camera image IMG1 is corrected on the basis of the generated information, and a corrected image IMG2 is output.

In FIG. 1, the image processing apparatus 120 is built in the vehicle lamp 10, but the present invention is not limited thereto, and the image processing apparatus 120 may be provided on the vehicle side.

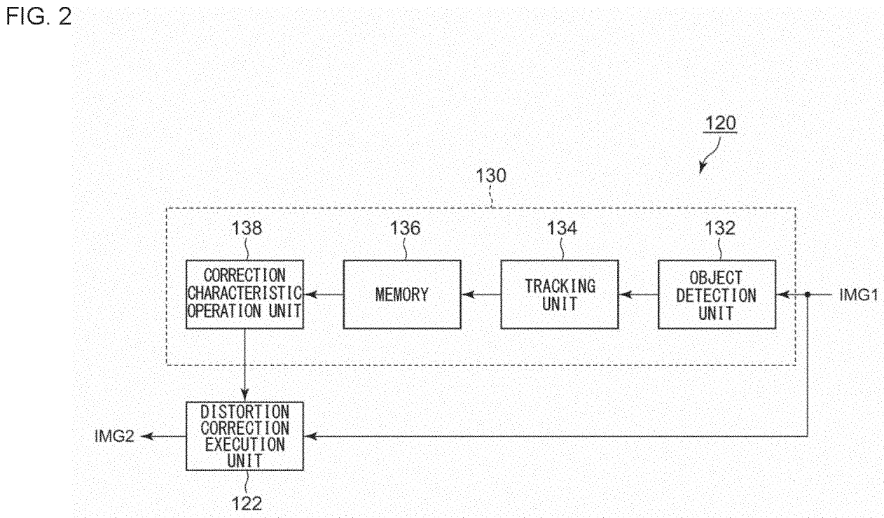

FIG. 2 is a functional block diagram of the image processing apparatus 120. The image processing apparatus 120 can be implemented by a combination of a processor (hardware) such as a central processing unit (CPU), a micro processing unit (MPU), or a microcomputer, and a software program executed by the processor (hardware). Therefore, each block illustrated in FIG. 2 merely illustrates processing performed by the image processing apparatus 120. The image processing apparatus 120 may be a combination of a plurality of processors. The image processing apparatus 120 may be configured only by hardware.

The image processing apparatus 120 includes a distortion correction execution unit 122 and a correction characteristic acquisition unit 130. The correction characteristic acquisition unit 130 generates information necessary for distortion correction on the basis of the image (camera image) IMG1 from the camera 110. The distortion correction execution unit 122 performs correction processing on the basis of the information generated by the correction characteristic acquisition unit 130.

The correction characteristic acquisition unit 130 of the image processing apparatus 120 tracks an object image included in the output image IMG1 of the camera 110, and generates information for correcting distortion of the output image IMG1 on the basis of a change in shape accompanying movement of the object image.

The correction characteristic acquisition unit 130 includes an object detection unit 132, a tracking unit 134, a memory 136, and a correction characteristic operation unit 138. The object detection unit 132 detects an object included in the camera image (frame) IMG1. The tracking unit 134 monitors the movement of the same object included in a plurality of consecutive frames, and defines the position and the shape of the object in the memory 136 in association with each other.

The correction characteristic operation unit 138 generates information (for example, parameters and correction functions) necessary for distortion correction on the basis of the data stored in the memory 136.

The camera image IMG1 captured by the camera 110 includes a region (hereinafter, referred to as a reference region) in which distortion is negligibly small. Typically, the distortion decreases toward the center of the camera image, and the distortion increases toward the outer periphery. In this case, it is sufficient that a reference region REF is provided at the center of the camera image.

When the object being tracked is included in the reference region REF, the correction characteristic operation unit 138 sets the shape of the object at that time as a true shape. Then, the correction characteristic operation unit 138 generates information for distortion correction on the basis of the relationship between the shape of the same object at an arbitrary position outside the reference region and the true shape.

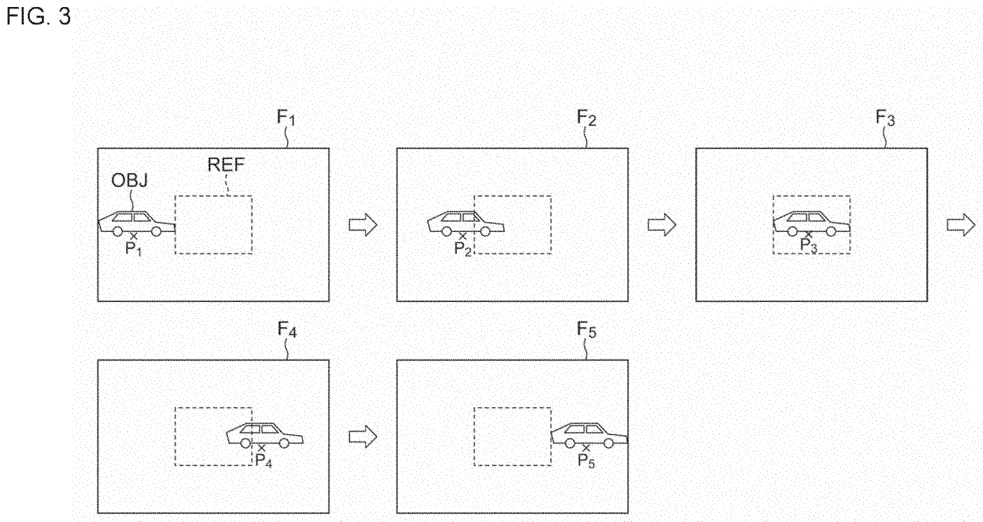

The above is the configuration of the imaging system 100. Next, the operation thereof will be described. FIG. 3 is a diagram for explaining the operation of the imaging system 100. FIG. 3 illustrates a plurality of consecutive frames F₁ to F₅, and illustrates a state in which an object (automobile) moves from the left to the right of the screen. When detecting an object OBJ, the object detection unit 132 tracks the object OBJ. At the center of the frame, the reference region REF is illustrated.

The shape of the object OBJ in each frame is sequentially stored in the memory 136 in association with the positions P₁ to P₅. In the frame F₃ the object OBJ is included in the reference region REF. Therefore, the shape of the object OBJ in the frame F₃ is set to a true shape S_{REF}.

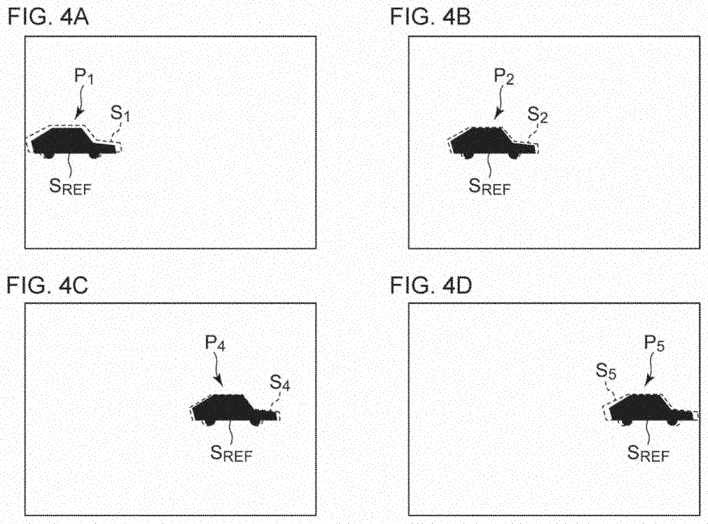

FIGS. 4A to 4D are diagrams illustrating shapes S₁, S₂ S₄, and S₅ of objects at positions P₁, P₂, P₄, and P₅ in comparison with the true shape S_{REF}. The distortion correction at a position P_{#} ( #=1, 2, 4, 5) is nothing less than matching the shape S_{#} with the true shape S_{REF}. The correction characteristic operation unit 138 calculates a correction characteristic (function or parameter) for converting the shape S_{#} into the true shape S_{REF} at each position P_{#}.

By repeating tracking for various objects, it is possible to generate correction characteristics for many points.

According to the imaging system 100 of the Embodiment 1.1, calibration for distortion correction is unnecessary at the design stage. Therefore, the shape (that is, optical characteristics) of the outer lens 14 can be freely designed.

In addition, there is an advantage that, in a case where the positional displacement of the camera 110 occurs after the automobile on which the imaging system 100 is mounted is shipped, the correction characteristic corresponding to the distortion due to the optical characteristic after the positional displacement is automatically generated.

The correction characteristic acquisition unit 130 may always operate during traveling. Alternatively, the correction characteristic acquisition unit 130 may operate every time until the learning of the correction characteristic is completed after the ignition is turned on, and may stop the operation after the learning is completed. After the ignition is turned off, the already learned correction characteristic may be discarded, or may be held until the next ignition is turned on.

In the above description, a region having small distortion is set as the reference region REF, but the present invention is not limited thereto, and a region having a known distortion characteristic (correction characteristic that is an inverse characteristic thereof) may be set as the reference region REF. In this case, the shape of the object included in the reference region REF can be corrected on the basis of the correction characteristic, and the corrected shape can be set to a true shape. According to this idea, the range in which the correction characteristic is once obtained can be treated as the reference region REF thereafter.

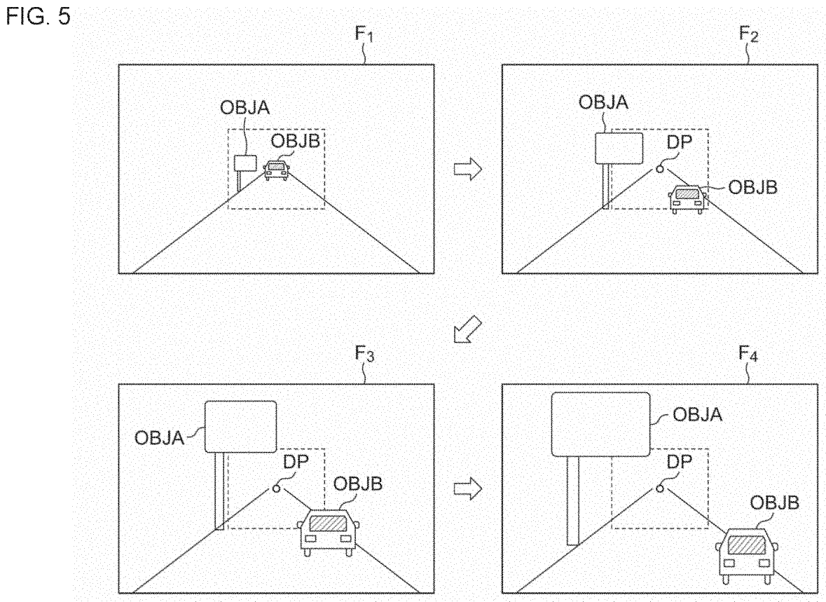

When an object approaching from a distance is captured by a camera, an image of the object appears from a vanishing point and moves from the vanishing point to the surroundings. The camera 110 may be arranged such that the vanishing point is included in the reference region REF. FIG. 5 is a diagram for explaining tracking in a case where the reference region REF includes a vanishing point DP. In this example, a signboard OBJA and an oncoming vehicle OBJB are captured in the camera. In the initial frame F₁, since the signboard OBJA and the oncoming vehicle OBJB are included in the reference region REF, their true shapes S_{REFA} and S_{REFB} can be acquired in the initial frame F₁. Thereafter, when the positions of the frames F₂, F₃, and F₄ and the object image move, the correction characteristic at each point can be acquired.

### Embodiment 1.2

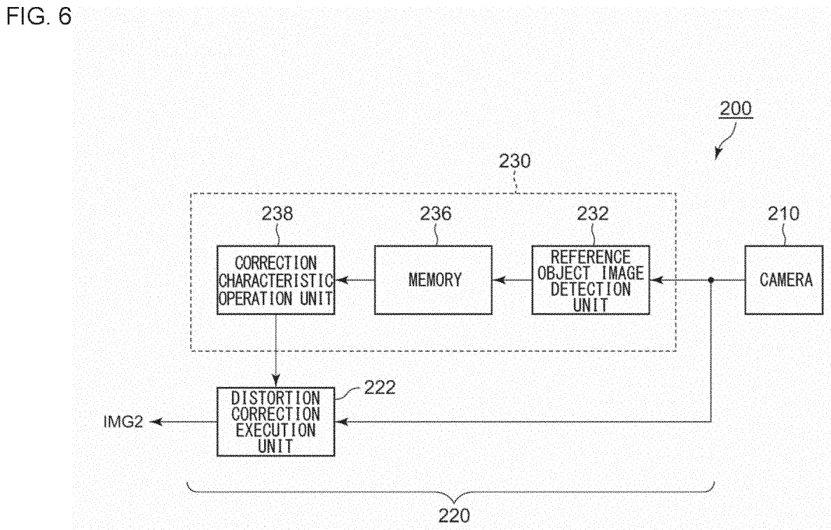

FIG. 6 is a block diagram of an imaging system 200 according to Embodiment 1.2. The imaging system 200 may be built in the vehicle lamp 10 as in Embodiment 1.1. The imaging system 200 includes a camera 210 and an image processing apparatus 220. As in Embodiment 1.1, the image processing apparatus 220 generates information (parameters and functions) necessary for correcting distortion including the influence of the camera 210 and the outer lens 14 on the basis of the output image IMG1 of the camera 210. Then, the camera image IMG1 is corrected on the basis of the generated information, and a corrected image IMG2 is output.

The image processing apparatus 220 includes a distortion correction execution unit 222 and a correction characteristic acquisition unit 230. The correction characteristic acquisition unit 230 detects an image of a reference object OBJ_{REF} whose true shape is known from the camera image IMG1. Then, the correction characteristic acquisition unit 230 generates information for correcting the distortion of the camera image IMG1 on the basis of the true shape S_{REF} of the image of the reference object OBJ and the shape S_{#} of the object image in the output image IMG1. The distortion correction execution unit 222 corrects the camera image IMG1 using the information generated by the correction characteristic acquisition unit 230.

The correction characteristic acquisition unit 230 includes a reference object detection unit 232, a memory 236, and a correction characteristic operation unit 238. The reference object detection unit 232 detects an image of the reference object OBJ_{REF} whose true shape S_{REF} is known from the camera image IMG1. As the reference object OBJ, a traffic sign, a utility pole, a road surface sign, or the like can be used.

The reference object detection unit 232 stores the shape S_{#} of the image of the detected reference object OBJ_{REF} in the memory 236 in association with the position P_{#}. As in Embodiment 1.1, the reference object OBJ_{REF} once detected may be tracked to continuously acquire the relationship between the position and the shape.

The correction characteristic operation unit 238 performs operation of a correction characteristic for each position P_{#} on the basis of the relationship between the shape S_{#} of the reference object image OBJ_{REF} and the true shape S_{REF}.

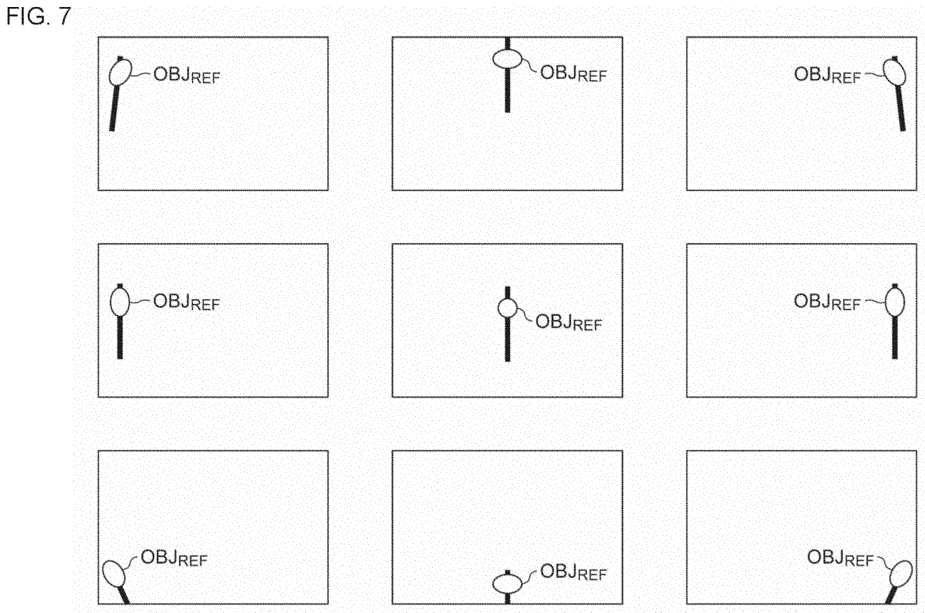

The above is the configuration of the imaging system 200. Next, the operation thereof will be described. FIG. 7 is a diagram for explaining operation of the imaging system 200 in FIG. 6. In this example, the reference object OBJ_{REF} is a traffic sign, and its true shape S_{REF} is a true circle. When a plurality of images (frames) as illustrated in FIG. 6 are obtained, a correction characteristic may be generated such that the distorted shape of the reference object OBJ_{REF} becomes a perfect circle.

Embodiment 1.2 is effective in a case where the reference region REF with small distortion cannot be defined in an image.

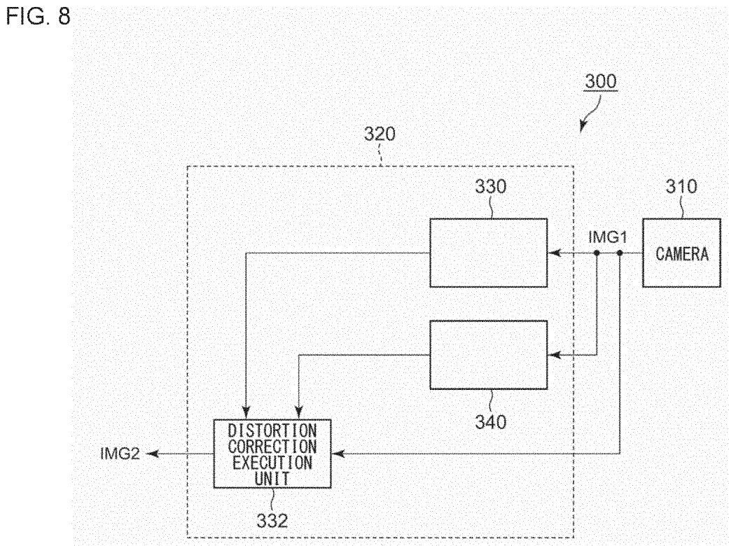

FIG. 8 is a block diagram of an imaging system 300 according to Embodiment 1.3. The imaging system 300 includes a camera 310 and an image processing apparatus 320. The image processing apparatus 320 includes a distortion correction execution unit 322, a first correction characteristic acquisition unit 330, and a second correction characteristic acquisition unit 340. The first correction characteristic acquisition unit 330 is the correction characteristic acquisition unit 130 in Embodiment 1.1, and the second correction characteristic acquisition unit 340 is the correction characteristic acquisition unit 230 in the Embodiment 1.2. That is, the image processing apparatus 320 supports both image correction using the reference region and image correction using the reference object.

### Outline of Embodiment 2

An embodiment disclosed in the present specification relates to an imaging system for a vehicle. The imaging system includes a camera and an image processing apparatus that processes an output image by the camera. When a foreign object is included in a current frame of the output image, the image processing apparatus searches the past frame for a background image shielded by the foreign object, and attaches the background image on the foreign object region where the foreign object exists in the current frame.

In an in-vehicle imaging system, since a camera moves as a vehicle moves, an object image included in a camera image continues to move. On the other hand, when a foreign object adheres, the foreign object tends to remain at the same position or move slower than the object image. That is, there is a high possibility that the object image existing in the foreign object region currently shielded by the foreign object has existed in a region different from the foreign object region in the past, and thus has not been shielded by the foreign object. Therefore, the missing of the image can be recovered by detecting the background image from the past frame and attaching the background image as a patch to the foreign object region.

The image processing apparatus may detect an edge for each frame of the output image and set a region surrounded by the edge as a candidate for the foreign object region. When the foreign object is a raindrop, the raindrop shines due to reflection of the lamp at night, and thus appears as a bright spot in the camera image. On the other hand, in the daytime (when the lamp is turned off), a raindrop shields light, and the portion appears as a dark spot. Therefore, by detecting the edge, a foreign object such as a raindrop can be detected.

However, by only the processing, there is a possibility that an object having an edge other than a raindrop is erroneously determined as a foreign object. Therefore, the image processing apparatus may determine a candidate for the foreign object region as the foreign object region when the candidate remains at substantially the same position over a predetermined number of frames. Since a foreign object can be regarded as being stationary on a time scale of about several frames to several tens of frames, by incorporating this property into the foreign object determination condition, erroneous determination can be prevented.

As another method, a foreign object may be detected by pattern matching, and in this case, detection for each frame is possible. However, it is necessary to increase the variation of the pattern according to the type of the foreign object, the traveling environment (daytime or night, weather, turning on/off of head lamp of own or other vehicle), and the like, and the processing becomes complicated. In this respect, the edge-based foreign object detection is advantageous because the processing can be simplified.

The image processing apparatus may detect an edge for each frame of the output image, and when edges having the same shape exist at the same place of two frames separated by N frames (N≥2), the image processing apparatus may determine a range surrounded by the edges as a foreign object region. In this case, it is not necessary to determine the frame interposed therebetween, so that the load on the image processing apparatus can be reduced.

The image processing apparatus may define the current reference region in the vicinity of the foreign object region in the current frame, detect the past reference region corresponding to the current reference region in the past frame, detect the offset amounts of the current reference region and the past reference region, and set the region obtained by shifting the foreign object region based on the offset amount in the past frame as the background image. As a result, it is possible to efficiently search for a background image to be used as a patch.

The detection of the past reference region may be based on pattern matching. In a case where a raindrop or the like adheres as a foreign object, there is a high possibility that there is no feature point available for optical flow operation around the foreign object region. In addition, the optical flow is originally a technique of tracking the movement of light (object) from the past toward the future. However, since the background image search is a process going back from the present to the past, it is necessary to buffer a plurality of consecutive frames and invert the time axis to apply the optical flow, and enormous operation processing is required. Alternatively, in the past frame, it is also conceivable to monitor all portions that can become the reference region in the future and apply the optical flow, but this also requires enormous operation processing. By using pattern matching, the past reference region can be efficiently searched for.

The detection of the past reference region may be based on an optical flow. In a case where a feature point usable in the optical flow operation exists in the current reference region, the past reference region can be searched for by tracing back the movement of the feature point on the time axis.

The image processing apparatus may detect an edge for each frame of the output image, when edges having the same shape exist at the same position of two frames separated by N frames, determine a range surrounded by the edges as a foreign object region, define a current reference region in the vicinity of the foreign object region in the current frame of the two frames, detect a past reference region corresponding to the current reference region in the past frame of the two frames, detect offset amounts of the current reference region and the past reference region, and set a region obtained by shifting the foreign object region on the basis of the offset amount in the past frame as the background image.

The image processing apparatus may detect the foreign object region by pattern matching.

The camera may be built in the lamp and capture an image through the outer lens.

Embodiment 2 will be described below with reference to the drawings.

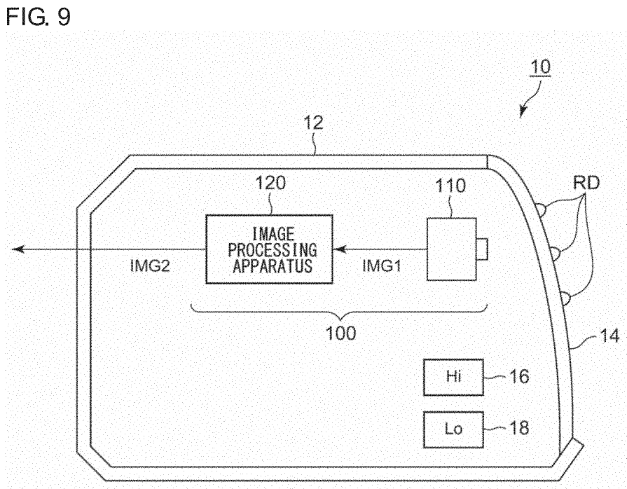

FIG. 9 is a block diagram of the imaging system 100 according to Embodiment 2. The imaging system 100 includes a camera 110 and an image processing apparatus 120. The camera 110 is built in a lamp body 12 of a vehicle lamp 10 such as an automobile headlamp. In addition to the camera 110, lamp light sources of a high beam 16 and a low beam 18, lighting circuits thereof, a heat sink, and the like are built in the vehicle lamp 10.

The camera 110 generates the camera image IMG1 at a predetermined frame rate. The camera 110 images the front of the camera via the outer lens 14, and a foreign object such as a raindrop RD, snow particle, or mud adhere to the outer lens 14. The foreign object is reflected in the camera image IMG1 and causes missing of an image. In the description below, a raindrop RD is assumed as a foreign object, but the present disclosure is also effective for a snow particle, mud, or the like.

When a foreign object is included in a current frame Fᵢ of the camera image IMG1, the image processing apparatus 120 searches the past frame Fⱼ (j<i) for a background image shielded by the foreign object, and attaches the background image to the foreign object region in the current frame. Then, the image processing apparatus 120 outputs the corrected image (hereinafter, referred to as a corrected image) IMG2.

The above is the basic configuration of the imaging system 100. Next, the operation thereof will be described.

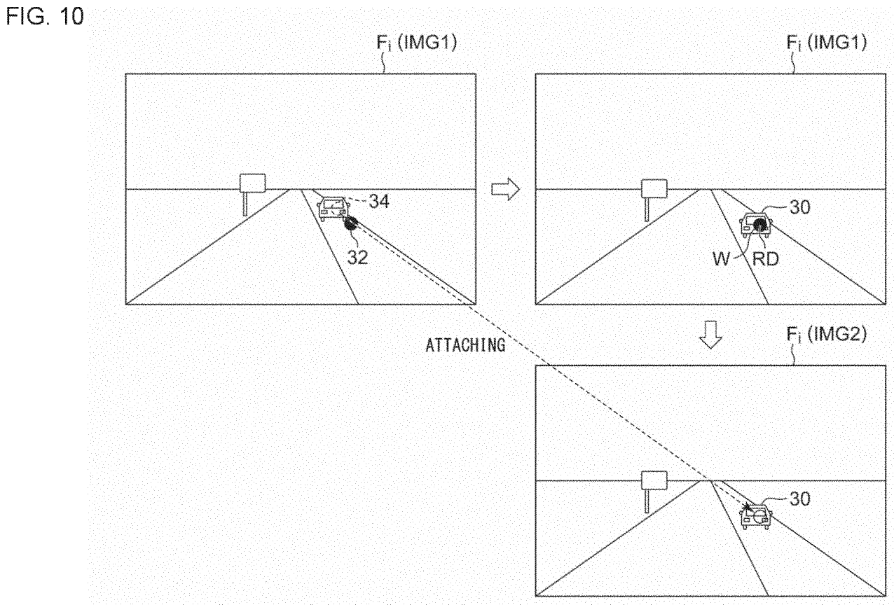

FIG. 10 is a diagram for explaining operation of the imaging system 100 in FIG. 9. The upper part of FIG. 10 illustrates the camera image IMG1, and the lower part illustrates the corrected image IMG2. In the upper part, the current frame Fᵢ and the past frame Fⱼ are illustrated. The oncoming vehicle 30 is shown in the current frame Fᵢ. Further, a foreign object (water droplet) RD is shown in a region 32 overlapping with the oncoming vehicle 30, and a part of the oncoming vehicle (background) 30 is shielded by the foreign object. A region where the foreign object RD exists is referred to as the foreign object region 32. A portion of the background (oncoming vehicle 30) that is shielded by the foreign object RD is referred to as a background image.

The image processing apparatus 120 searches the past frame Fⱼ (j<i) for the background image 34 shielded by the foreign object RD, and attaches the background image 34 to the foreign object region 32 of the current frame Fᵢ.

The above is the operation of the imaging system 100. In an in-vehicle imaging system, since the camera 110 moves as a vehicle moves, an object image (background) included in the camera image IMG1 continues to move. On the other hand, when the foreign object 32 adheres, the foreign object tends to remain at the same position or move slower than the object image. That is, there is a high possibility that the object image (oncoming vehicle 30) existing in the foreign object region shielded by the foreign object 32 in the current frame Fᵢ has existed in a region different from the foreign object region in the past frame Fⱼ, and thus has not been shielded by the foreign object. Therefore, the missing of the image can be recovered by detecting the background image from the past frame Fⱼ and attaching the background image as a patch to the foreign object region.

Next, specific processing will be described.

### Foreign Object Detection

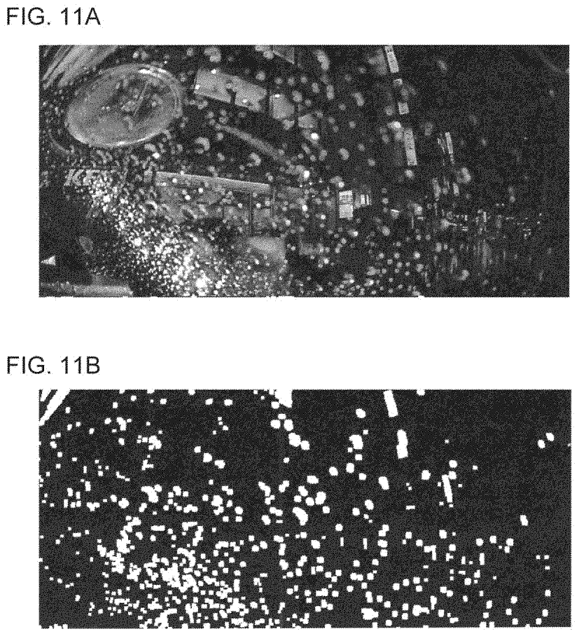

The image processing apparatus 120 detects edges for each frame of the camera image IMG1 and determines a region surrounded by the edge as a candidate for the foreign object region. FIGS. 11A and 11B are diagrams for explaining determination of the foreign object region based on edge detection. FIG. 11A is a camera image IMG1 captured through raindrops, and FIG. 11B is an image illustrating a candidate of the foreign object region.

As illustrated in FIG. 11B, it can be seen that the foreign object region where a raindrop exists can be preferably detected by extracting an edge. However, in FIG. 11B, a background that is not a foreign object is also erroneously determined as a foreign object. Here, in an in-vehicle application in which a camera moves, it can be considered that a foreign object is stationary in a time scale of several to several tens of frames. Therefore, by incorporating this property into the foreign object determination condition, erroneous determination can be prevented. Specifically, the image processing apparatus 120 may finally determine a candidate for the foreign object region as the foreign object region when the candidate remains at substantially the same position over a predetermined number of frames.

In this case, the image processing apparatus 120 may compare two frames separated by N frames, and when edges having the same shape exist at the same position, the image processing apparatus 120 may consider that the edges exist at the same position also in the frames therebetween, and determine the range surrounded by the edges as the foreign object region. As a result, the operation processing amount of the image processing apparatus 120 can be reduced.

As another method, a foreign object may be detected by pattern matching, and in this case, detection for each frame is possible. However, it is necessary to increase the variation of the pattern according to the type of the foreign object, the traveling environment (daytime or night, weather, turning on/off of head lamp of own or other vehicle), and the like. Therefore, there is an advantage in the foreign object detection based on the edge. In the present disclosure, in a case where the operation processing capability of the image processing apparatus has a margin, pattern matching may be used for foreign object detection.

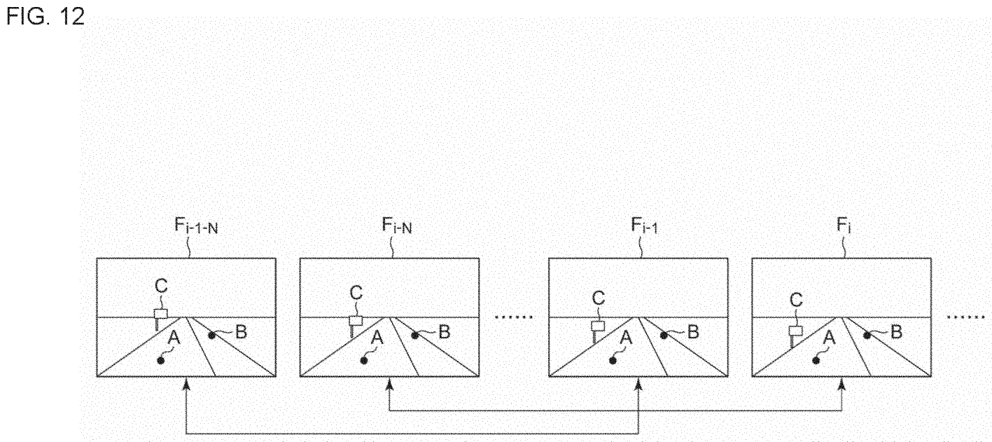

FIG. 12 is a diagram for explaining foreign object detection. In each frame, three edges A to C, that is, foreign object region candidates are detected. When Fᵢ₋₁ is the current frame, comparison is made with F_{i-1N} that is N frames earlier. Since the edges A and B exist at the same position, it is finally determined that the edges A and B are foreign objects. On the other hand, since the positions of the edge C are different between the two frames Fᵢ₋₁ and F_{i-1N}, the edge C is excluded from the foreign object.

When Fᵢ is the current frame, comparison is made with F_{i-N} that is N frames earlier. Since the edges A and B exist at the same position, it is finally determined that the edges A and B are foreign objects. On the other hand, since the positions of the edge C are different between the two frames Fᵢ and F_{i-N}, the edge C is excluded from the foreign object.

By repeating this process, the foreign object region can be efficiently detected. It is also conceivable to use pattern matching as a foreign object detection method. While pattern matching has an advantage that detection can be performed for each frame, there is a problem that it is necessary to increase a variation of a matching pattern according to a type of a foreign object, a traveling environment (daytime or night, weather, turning on/off of head lamp of own or other vehicle), and the like, and an operation processing amount increases. According to the foreign object determination based on the edge detection, such a problem can be solved.

### Search for Background Image

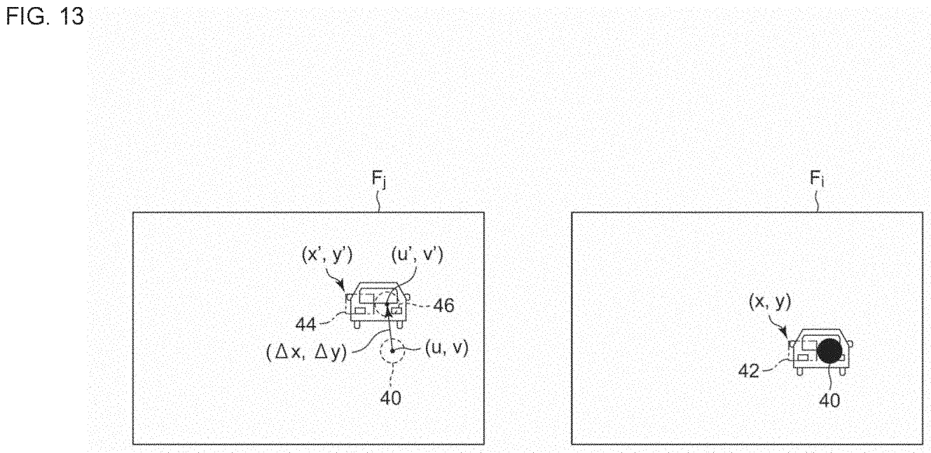

FIG. 13 is a diagram for explaining search for a background image. FIG. 13 illustrates the current frame Fᵢ and the past frame Fⱼ. The past frame Fⱼ may be F_{i-N}. The image processing apparatus 120 defines a current reference region 42 in the vicinity of the foreign object region 40 in the current frame Fᵢ. Then, the image processing apparatus 120 detects a past reference region 44 corresponding to the current reference region 42 in the past frame Fⱼ.

Pattern matching or an optical flow can be used to detect the past reference region 44, but pattern matching may be used for the following reasons. In a case where a raindrop or the like adheres as a foreign object, there is a high possibility that there is no feature point available for optical flow operation around the foreign object region. In addition, the optical flow is originally a technique of tracking the movement of light (object) from the past toward the future. However, since the background image search is a process going back from the present to the past, it is necessary to buffer a plurality of consecutive frames and invert the time axis to apply the optical flow, and enormous operation processing is required. Alternatively, in the past frame, it is also conceivable to monitor all portions that can become the reference region in the future and apply the optical flow, but this also requires enormous operation processing. On the other hand, by using pattern matching, it is possible to search for the past reference region efficiently with a small number of operations.

Then, offset amounts Δx (=x′−x) and Δy (=y′−y) of the position (x, y) of the current reference region 42 and the position (x′, y′) of the past reference region 44 are detected. Here, the reference region is rectangular, but its shape is not limited thereto.

In the past frame Fⱼ, a region obtained by shifting the foreign object region 40 on the basis of the offset amounts Δx and Δy is defined as a background image 46. The following relationship holds between the position (u′, v′) of the background image 46 and the position (u, v) of the foreign object region.

u′=u+Δx

v′=v+Δy

The above is the background image search method. According to this method, it is possible to efficiently search for a background image to be used as a patch.

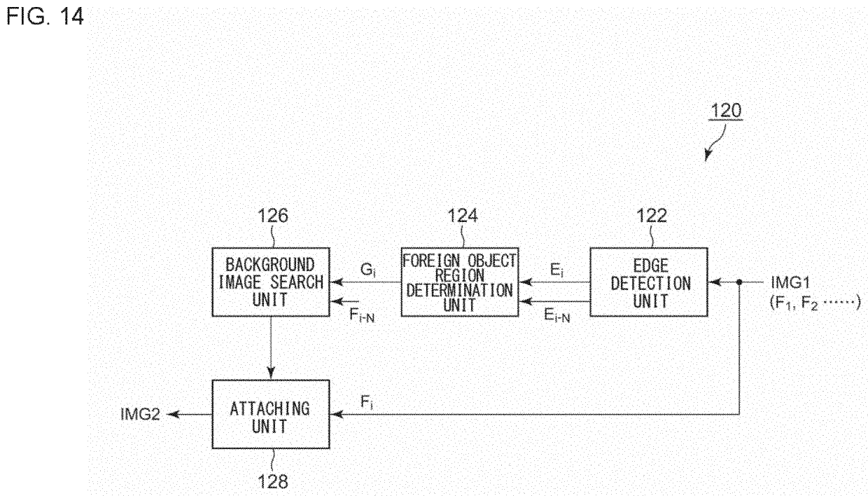

FIG. 14 is a functional block diagram of the image processing apparatus 120. The image processing apparatus 120 can be implemented by a combination of a processor (hardware) such as a central processing unit (CPU), a micro processing unit (MPU), or a microcomputer, and a software program executed by the processor (hardware). Therefore, each block illustrated in FIG. 14 merely illustrates processing performed by the image processing apparatus 120. The image processing apparatus 120 may be a combination of a plurality of processors. The image processing apparatus 120 may be configured only by hardware.

The image processing apparatus 120 includes an edge detection unit 122, a foreign object region determination unit 124, a background image search unit 126, and an attaching unit 128. The edge detection unit 122 detects edges for the current frame Fᵢ and generates edge data Eᵢ including information on the detected edge.

The foreign object region determination unit 124 refers to the edge data Eᵢ of the current frame Fᵢ and edge data E_{i-N} of the past frame Fⱼ (=F_{i-N}) determines a region surrounded by stationary edges as a foreign object region, and generates foreign object region data Gᵢ.

The background image search unit 126 searches for a background image available as a patch on the basis of the foreign object region data Gᵢ, the current frame Fᵢ, and the past frame F_{i-N}. The processing is as described with reference to FIG. 13, the current reference region is defined in the vicinity of the foreign object region data Gᵢ in the current frame Fᵢ, and the past reference region corresponding to the current reference region is extracted from the past frame F_{i-N}. Then, the offset amounts Δx and Δy are detected to detect the background image. The attaching unit 128 attaches the background image detected by the background image search unit 126 to the corresponding foreign object region of the current frame Fᵢ.

A modification related to Embodiment 2 will be described.

### Modification 2.1

In the embodiments, when the foreign object region is detected, the past frame N frames earlier than the current frame is referred to, and when the background image used as the patch is searched for, the past frame N frames earlier than the current frame is referred to, but the present invention is not limited thereto. The search for the background image may use a past frame M frames (N≠M) earlier than the current frame. In a case where an appropriate background image cannot be detected in a certain past frame, the background image may be further searched for from the past frame.

### Modification 2.2

In the embodiments, the candidate of the foreign object region is searched for on the basis of the edge. At this time, the shape and size of the edge may be given as a constraint. For example, since the shape of raindrops is often circular or elliptical, figures having corners can be excluded. Accordingly, it is possible to prevent a signboard or the like from being extracted as a candidate for a foreign object.

### Outline of Embodiment 3

Embodiment 3 relates to an imaging system for a vehicle. An imaging system includes a camera that generates a camera image, and an image processing apparatus that processes the camera image. When a water droplet is shown in a camera image, the image processing apparatus performs operation of a lens characteristic of the water droplet and corrects an image in a region of the water droplet on the basis of the lens characteristic.

According to this configuration, it is possible to correct the distortion due to the water droplet by calculating the distortion (lens characteristic) of the optical path due to the lens action of the water droplet and calculating the optical path when the lens action of the water droplet does not exist.

The image processing apparatus may set a predetermined region of the camera image as an image correction target. When the entire range of the camera image is to be subjected to the distortion correction, the operation amount of the image processing apparatus increases, and a high-speed processor is required. Therefore, by setting only an important region of the camera image as a correction target, the amount of operation required for the image processing apparatus can be reduced. The “important region” may be fixed or dynamically set.

The image processing apparatus may detect an edge for each frame of the camera image and set a region surrounded by edges as a candidate for the water droplet. At night, a water droplet shines due to reflection of the lamp, and thus appears as a bright spot in the camera image. On the other hand, in the daytime (when the lamp is turned off), a water droplet shields light, and the portion appears as a dark spot. Therefore, by detecting the edge, a water droplet can be detected.

However, by only the processing, there is a possibility that an object having an edge other than a water droplet is erroneously determined as a water droplet. Therefore, the image processing apparatus may determine a candidate for the water droplet as the water droplet when the candidate remains at substantially the same position over a predetermined number of frames. Since a water droplet can be regarded as being stationary on a time scale of about several frames to several tens of frames, by incorporating this property into the water droplet determination condition, erroneous determination can be prevented.

The image processing apparatus may determine a candidate for the water droplet as the water droplet when the candidate remains at substantially the same position over a predetermined number of frames.

As another method, a water droplet may be detected by pattern matching, and in this case, detection for each frame is possible. However, it is necessary to increase the variation of the pattern according to the traveling environment (daytime or night, weather, turning on/off of head lamp of own or other vehicle), and the like, and the processing becomes complicated. In this respect, the edge-based water droplet detection is advantageous because the processing can be simplified.

The image processing apparatus may detect an edge for each frame of the camera image, and when edges having the same shape exist at the same place of two frames separated by N frames, the image processing apparatus may determine a range surrounded by the edges as a water droplet.

The camera may be built in the lamp and capture an image through the outer lens.

Embodiment 3 discloses an image processing apparatus that is used with a camera and included in an imaging system for a vehicle. When a water droplet is shown in a camera image generated by the camera, the image processing apparatus operates a lens characteristic of the water droplet and corrects an image in a region of the water droplet on the basis of the lens characteristic.

Embodiment 3 will be described below in detail with reference to the drawings.

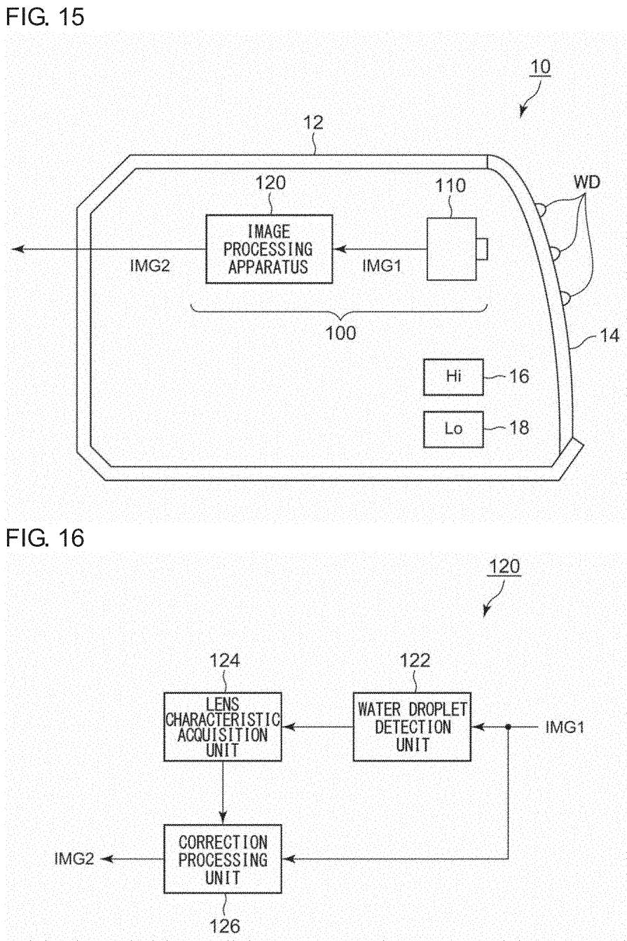

FIG. 15 is a block diagram of the imaging system 100 according to Embodiment 3. The imaging system 100 includes a camera 110 and an image processing apparatus 120. The camera 110 is built in a lamp body 12 of a vehicle lamp 10 such as an automobile headlamp. In addition to the camera 110, lamp light sources of a high beam 16 and a low beam 18, lighting circuits thereof, a heat sink, and the like are built in the vehicle lamp 10.

The camera 110 generates the camera image IMG1 at a predetermined frame rate. The camera 110 images the front of the camera via the outer lens 14, and a water droplet WD such as a raindrop may adhere to the outer lens 14. Since the water droplet WD acts as a lens, the path of the light beam passing through the water droplet WD is refracted and distorts the image.

When the water droplet WD is included in the camera image IMG1, the image processing apparatus 120 performs operation of a lens characteristic of the water droplet WD and corrects an image in a region of the water droplet WD on the basis of the lens characteristic.

Details of processing of the image processing apparatus 120 will be described. FIG. 16 is a functional block diagram of the image processing apparatus 120. The image processing apparatus 120 can be implemented by a combination of a processor (hardware) such as a central processing unit (CPU), a micro processing unit (MPU), or a microcomputer, and a software program executed by the processor (hardware). Therefore, each block illustrated in FIG. 16 merely illustrates processing performed by the image processing apparatus 120. The image processing apparatus 120 may be a combination of a plurality of processors. The image processing apparatus 120 may be configured only by hardware.

The image processing apparatus 120 includes a water droplet detection unit 122, a lens characteristic acquisition unit 124, and a correction processing unit 126. The water droplet detection unit 122 detects one or a plurality of water droplets WD from the camera image IMG1. The lens characteristic acquisition unit 124 calculates the lens characteristic of each water droplet WD on the basis of the shape and position thereof.

The correction processing unit 126 corrects the image in the region of each water droplet on the basis of the lens characteristic obtained by the lens characteristic acquisition unit 124.

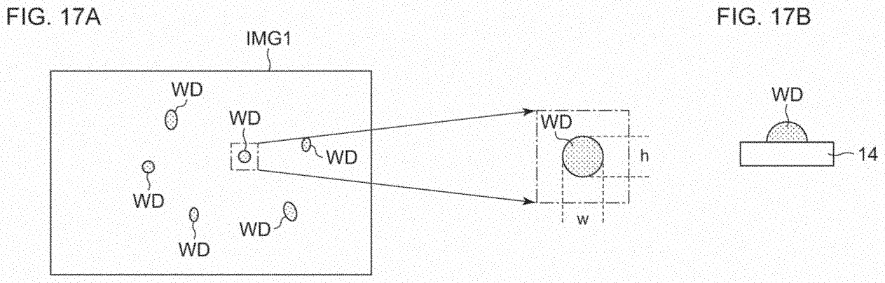

The above is the configuration of the imaging system 100. Next, the operation thereof will be described. FIGS. 17A and 17B are diagrams for explaining estimation of the lens characteristic. FIG. 17A illustrates the camera image IMG1. The water droplet detection unit 122 detects the water droplet WD from the camera image IMG1 and acquires the shape (for example, width w and height h) and position of the water droplet WD. When the shape and position of the water droplet WD can be acquired, as illustrated in FIG. 17B, the cross-sectional shape of the water droplet due to surface tension can be estimated, and the lens characteristic can be generated.

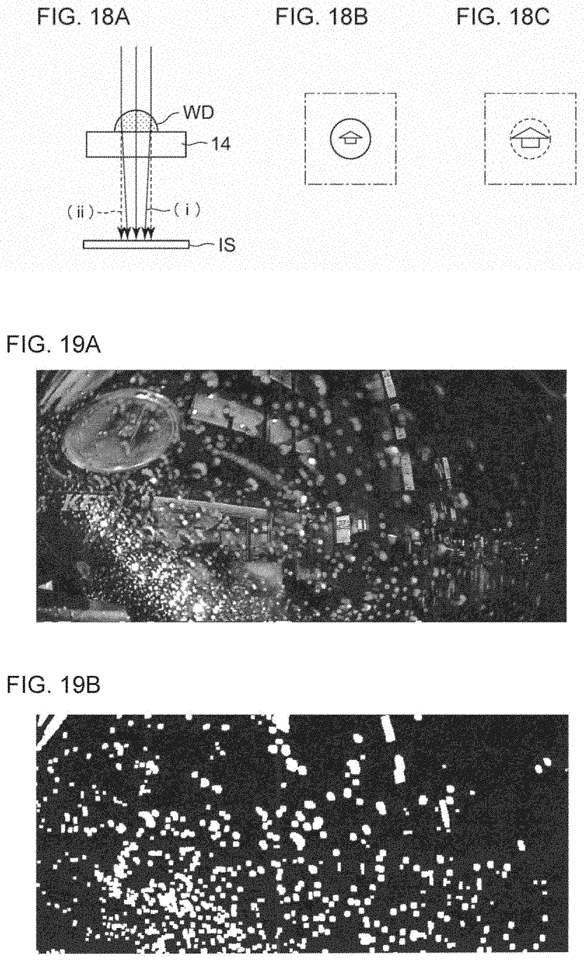

FIGS. 18A to 18C are diagrams for explaining image correction on the basis of the lens characteristic. FIG. 18A illustrates the lens effect by the water droplet WD, and the solid line indicates the actual light beam (i) refracted by the water droplet.

FIG. 18B illustrates a part of the camera image captured by an image sensor IS. The camera image IMG1 shows an image in which a solid line beam (i) is formed on the imaging surface of the image sensor IS, and in this example, an image reduced by refraction is formed on the image sensor IS.

The image processing apparatus 120 calculates an optical path of a light beam (ii) when it is assumed that there is no water droplet WD, and estimates an image formed on the imaging surface of the image sensor IS by the light beam (ii) as illustrated in FIG. 18C. The estimated image is the corrected image.

The above is the operation of the image processing apparatus 120. According to the imaging system 100, it is possible to correct the distortion due to the water droplet WD by calculating the distortion (lens characteristic) of the optical path due to the lens action of the water droplet WD and calculating the optical path when the lens action of the water droplet WD does not exist.

As illustrated in FIG. 17A, a plurality of water droplets may be simultaneously reflected in the camera image IMG1. In such a case, if all water droplets are to be corrected, the operation processing amount of the image processing apparatus 120 increases, and there is a possibility that the processing cannot be performed in time.

In order to solve this problem, the image processing apparatus 120 may set only a water droplet in a predetermined region in the camera image IMG1 as a correction target. The predetermined region is, for example, a region of interest (ROI), and may be the center of the image or a region including an object to be noted. Therefore, the position and shape of the predetermined region may be fixed or may dynamically change.

The image processing apparatus 120 may set only a water droplet including an image in a region inside the water droplet as a correction target. As a result, the operation processing amount can be reduced.

### Water droplet detection

Next, detection of a water droplet will be described. The image processing apparatus 120 detects edges for each frame of the camera image IMG1 and determines a region surrounded by edges as a candidate for a region where a water droplet exists (referred to as a water droplet region). FIGS. 19A and 19B are diagrams for explaining determination of a water droplet region based on edge detection. FIG. 19A is the camera image IMG1 captured after through water droplets, and FIG. 19B is an image showing a candidate of a water droplet region.

As illustrated in FIG. 19B, it can be seen that the water droplet region can be suitably detected by extracting the edge. However, in FIG. 19B, a background that is not a water droplet is also erroneously determined as a water droplet. Here, in an in-vehicle application in which a camera moves, it can be considered that a water droplet is stationary in a time scale of several to several tens of frames. Therefore, by incorporating this property into the water droplet determination condition, erroneous determination can be prevented. Specifically, the image processing apparatus 120 may finally determine a candidate for the water droplet region as the water droplet region when the candidate remains at substantially the same position over a predetermined number of frames.

In this case, the image processing apparatus 120 may compare two frames separated by N frames, and when edges having the same shape exist at the same position, the image processing apparatus 120 may consider that the edges exist at the same position also in the frames therebetween, and determine the range surrounded by the edges as the water droplet region. As a result, the operation processing amount of the image processing apparatus 120 can be reduced.

As another method, a water droplet may be detected by pattern matching, and in this case, detection for each frame is possible. However, it is necessary to increase the variation of the pattern according to the type of the water droplet, the traveling environment (daytime or night, weather, turning on/off of head lamp of own or other vehicle), and the like. Therefore, there is an advantage in the water droplet detection based on the edge. In the present disclosure, in a case where the operation processing capability of the image processing apparatus has a margin, pattern matching may be used for water droplet detection.

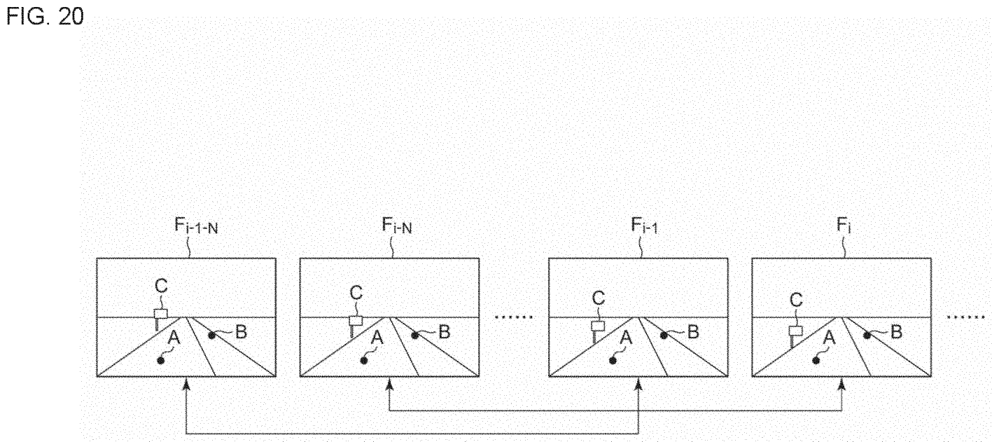

FIG. 20 is a diagram for explaining water droplet detection. Three edges A to C, that is, water droplet region candidates are detected in each frame. When Fᵢ₋ₗ is the current frame, comparison is made with F_{i-1N} that is N frames earlier. Since the edges A and B exist at the same position, it is finally determined that the edges A and B are water droplets. On the other hand, since the positions of the edge C are different between the two frames and Fᵢ₋₁ and F_{i-1N}, the edge C is excluded from the water droplet.

When Fᵢ is the current frame, comparison is made with F_{1-N} that is N frames earlier. Since the edges A and B exist at the same position, it is finally determined that the edges A and B are water droplets. On the other hand, since the positions of the edge C are different between the two frames Fᵢ and F_{i-N}, the edge C is excluded from the water droplet.

By repeating this process, the water droplet region can be efficiently detected. It is also conceivable to use pattern matching as a water droplet detection method. While pattern matching has an advantage that detection can be performed for each frame, there is a problem that it is necessary to increase a variation of a matching pattern according to a type of a water droplet, a traveling environment (daytime or night, weather, turning on/off of head lamp of own or other vehicle), and the like, and an operation processing amount increases. According to the water droplet determination based on the edge detection, such a problem can be solved.

A modification related to the Embodiment 3 will be described.

### Modification 3.1

In the embodiments, the candidate of the water droplet region is searched for on the basis of the edge. At this time, the shape and size of the edge may be given as a constraint. For example, since the shape of raindrops is often circular or elliptical, figures having corners can be excluded. Accordingly, it is possible to prevent a signboard or the like from being extracted as a candidate for a water droplet.

### Outline of Embodiment 4

Embodiment 4 relates to an imaging system for a vehicle. An imaging system includes a camera that is built in a vehicle lamp together with a lamp light source and generates a camera image at a predetermined frame rate, and an image processing apparatus that processes the camera image. The image processing apparatus extracts a reflection component of the emitted light of the lamp light source on the basis of a plurality of frames, and removes the reflection component from a current frame.

The reflected image to be removed is generated by reflection of a lamp as a fixed light source on an outer lens as a fixed medium, so that the reflected image can be regarded as unchanged for a long time. Therefore, a bright portion commonly included in the plurality of frames can be extracted as the reflection component. This method can be performed only by simple difference extraction or logical operation, and thus has an advantage that the amount of operation is small.

The image processing apparatus may generate the reflection component by taking a logical product for each pixel of a plurality of frames. The logical product operation may be generated by developing a pixel value (or a luminance value) of a pixel into binary and performing a logical product operation between corresponding digits of the corresponding pixel.

The plurality of frames may be separated by at least three seconds or more. As a result, an object other than reflected images is more likely to appear at different positions in a plurality of frames, and can be prevented from being erroneously extracted as reflected images.

The image processing apparatus may exclude a predetermined exclusion region determined from the positional relationship between the lamp light source and the camera from the reflection component extraction processing. In a case where an object (light source) to be captured by the camera is located far away, there is a possibility that the object is captured at the same position of two frames sufficiently separated in time and is erroneously extracted as reflection of the lamp light source. Therefore, erroneous extraction can be prevented by determining in advance a region where reflection of the lamp light source cannot occur.

The plurality of frames may be two frames. Even in the processing of only two frames, reflection can be detected with accuracy comparable to the processing of three or more frames.

The plurality of frames may be captured in a dark scene. As a result, the accuracy of the reflection extraction can be further improved.

Another aspect of the present disclosure relates to a vehicle lamp. The vehicle lamp includes a lamp light source and any of the imaging systems described above.

Embodiment 4 discloses an image processing apparatus that is used with a camera and included in an imaging system for a vehicle. The camera is built in a vehicle lamp together with a lamp light source. The image processing apparatus extracts a reflection component of emitted light of the lamp light source on the basis of a plurality of frames of a camera image generated by the camera, and removes the reflection component from a current frame.

Embodiment 4 will be described below in detail with reference to the drawings.

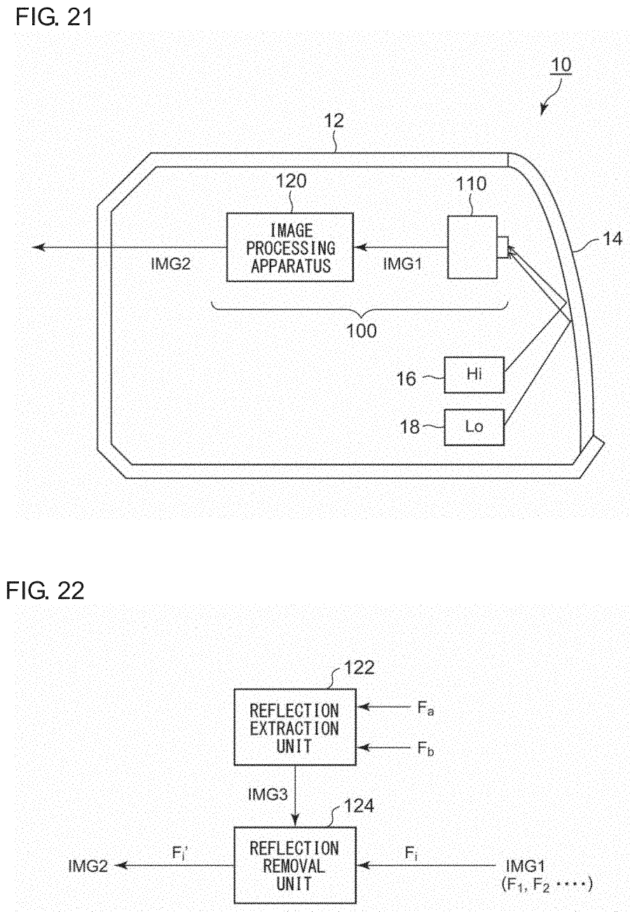

FIG. 21 is a block diagram of the imaging system 100 according to Embodiment 4. The imaging system 100 includes a camera 110 and an image processing apparatus 120. The camera 110 is built in a lamp body 12 of a vehicle lamp 10 such as an automobile headlamp. In addition to the camera 110, lamp light sources of a high beam 16 and a low beam 18, lighting circuits thereof, a heat sink, and the like are built in the vehicle lamp 10.

The camera 110 generates the camera image IMG1 at a predetermined frame rate. The camera 110 images the front of the camera via an outer lens 14. When the lamp light source such as the high beam 16 or the low beam 18 is turned on, the beam emitted from the lamp light source is reflected or scattered by the outer lens 14, and part of the beam is incident on the camera 110. As a result, the lamp light source is captured in the camera image IMG1. Although a simplified optical path is illustrated in FIG. 21, reflection may actually occur via a more complicated optical path.

The image processing apparatus 120 extracts a reflection component of emitted light of the lamp light source on the basis of a plurality of frames of the camera image IMG1, and removes the reflection component from a current frame.

Details of processing of the image processing apparatus 120 will be described. FIG. 22 is a functional block diagram of the image processing apparatus 120. The image processing apparatus 120 can be implemented by a combination of a processor (hardware) such as a central processing unit (CPU), a micro processing unit (MPU), or a microcomputer, and a software program executed by the processor (hardware). Therefore, each block illustrated in FIG. 22 merely illustrates processing executed by the image processing apparatus 120. The image processing apparatus 120 may be a combination of a plurality of processors. The image processing apparatus 120 may be configured only by hardware.

The image processing apparatus 120 includes a reflection extraction unit 122 and a reflection removal unit 124. The reflection extraction unit 122 generates a reflection image IMG3 including a reflection component on the basis of a set (in this example, two frames Fa, Fb) of two or three or more frames separated in time among a plurality of frames captured by the camera 110. A method of selecting the plurality of frames Fa and Fb for reflection extraction will be described later.

The reflection extraction unit 122 extracts a bright portion commonly reflected in the plurality of frames Fa and Fb as a reflection component. Specifically, the reflection extraction unit 122 can generate a reflection component (reflection image IMG3) by taking a logical product (AND) of each pixel of the plurality of frames Fa and Fb. The reflection extraction unit 122 obtains a logical product of corresponding digits (bits) when the pixel value (RGB) is developed into binary for all the pixels of the frames Fa and Fb. For the sake of simplicity, it is assumed that the red pixel value Ra of a certain pixel of the frame Fa is 8 and the pixel value Rb of the same pixel of the frame Fb is 11. It is expressed in 5 bits for simplicity as

Ra=[01000]

Rb=[01011]

and their logical product can be obtained by multiplying bits by each other, and expressed as

Ra×Rb=[01000]. By performing the logical product operation on all the pixels, the image IMG3 including the reflection component is generated. The reflection image IMG3 may be generated only once after the start of traveling, or may be updated at an appropriate frequency during traveling. Alternatively, the reflection image IMG3 may be generated at a frequency of several days or once every several months.

Instead of the RGB pixel values, the RGB pixel values may be converted into luminance values, and logical product operation may be performed on the luminance values to extract the reflection components.

The reflection removal unit 124 corrects each frame Fi of the camera image using the reflection image IMG3 to remove the reflection component.

The reflection removal unit 124 may multiply the pixel value of the reflection image IMG3 by a predetermined coefficient and subtract the pixel value from the original frame Fi. Fi (x, y) represents a pixel at a horizontal position x and a vertical position y in the frame Fi.

Fi′(x,y)=Fi(x,y)−β×IMG3(x,y)

β can be optimized by experiment so that the effect of reflection removal is the highest.

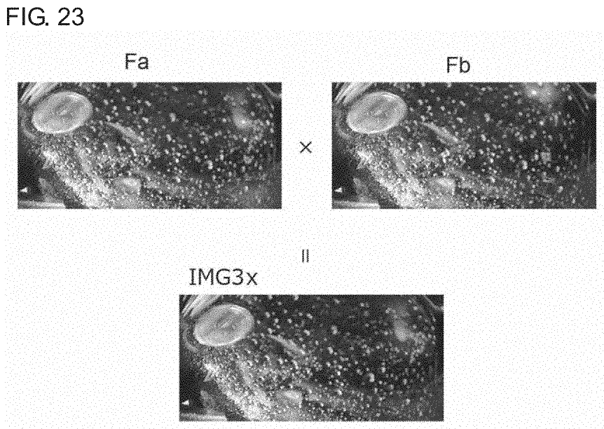

The above is the configuration of the imaging system 100. Next, the operation thereof will be described. FIG. 23 is a diagram for explaining generation of a reflection image IMG3x based on the two frames Fa and Fb. In this example, raindrops are attached to the outer lens, but reflection occurs regardless of the presence or absence of raindrops. The two frames Fa and Fb are captured at an interval of 3.3 seconds (100 frames at 30 fps) during traveling. By having an interval of 3 seconds or more, most objects appear at different positions, and thus can be removed by performing logical product operation. The plurality of frames used for generating the reflection image IMG3x are captured in a dark scene. As a result, the reflection of the background can be reduced, and the reflection component can be extracted with higher accuracy. The dark scene may be determined by image processing or by using an illuminance sensor.

On the right side of each of the two frames Fa and Fb, a street lamp or a road sign as a distant view component is shown. Since these are distant views, the position hardly moves in traveling for 3.3 seconds, and thus the components are mixed in the reflection image IMG3.

In order to solve this problem, an exclusion region may be defined in a frame. The position where the reflection occurs is geometrically determined from the positional relationship between the lamp light source and the camera, and thus does not change greatly. In other words, a region where reflection cannot occur is determined in advance as an excluded region, and can be excluded from the reflection component extraction processing. In the example of FIG. 23, the reflection is concentrated on the left side of the image, while the distant view (vanishing point) is concentrated on the right side of the image. Therefore, by setting the right half including the vanishing point as the exclusion region, it is possible to prevent a signboard, a street lamp, a sign, a light of a building, or the like in a distant view from being erroneously extracted as reflection.

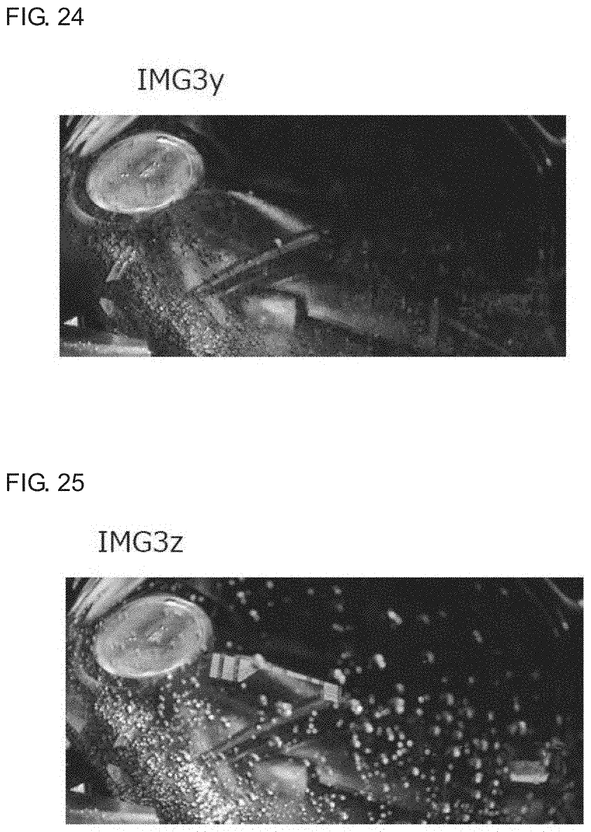

FIG. 24 is a diagram illustrating a reflection image IMG3y generated from four frames. The four frames used to generate the reflection image IMG3 are captured in different scenes in terms of time and place, and the logical product thereof is taken to generate the image IMG3y.

In the example of FIG. 23, raindrops and a part of the background are extracted as reflection. However, by using a frame captured in a completely different scene as in FIG. 24, raindrops and the background are removed, and only reflection components can be extracted more accurately.

FIG. 25 illustrates a reflection image IMG3z generated on the basis of two frames captured in a bright scene. When imaging in a bright scene, it is difficult to completely remove background light.

FIGS. 26A to 26D are diagrams illustrating an effect of removing reflection. FIG. 26A illustrates an original frame Fi. FIG. 26B illustrates an image obtained by correcting the original frame Fi using the reflection image IMG3x of FIG. 23. FIG. 26C illustrates an image obtained by correcting the original frame Fi using the reflection image IMG3y of FIG. 24. FIG. 26D illustrates an image obtained by correcting the original frame Fi using the reflection image IMG3z of FIG. 25. The coefficient β used for the correction was 0.75.

As can be seen from the comparison of FIGS. 26B to 26D, the influence of reflection can be removed well by using the image IMG3x obtained by the frame captured in the dark scene and the image IMG3y obtained by the frame captured in the completely different scene.

Ideally, it is desirable to generate the reflection image IMG3 using a frame captured in a state where the headlamp is covered with a blackout curtain. For example, a maintenance mode is performed on the imaging system 100, an instruction is given to a user or a work vehicle to cover a headlamp with a blackout curtain at the time of maintenance of the vehicle, and imaging is performed by the camera 110 to generate the reflection image IMG3.

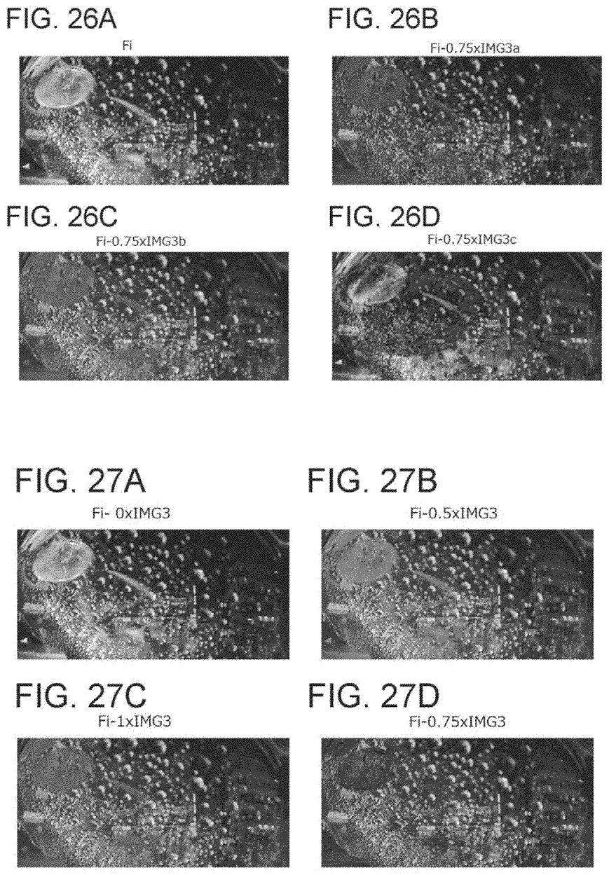

FIGS. 27A to 27D are diagrams for explaining the influence of coefficients in reflection removal. FIG. 27A illustrates a frame before correction, and FIGS. 27B to 27D illustrate an image IMG2 after correction when the coefficients β are 0.5, 0.75, and 1. When β=1, overcorrection occurs and the image becomes excessively dark. On the other hand, when β=0.5, the removal of reflection becomes insufficient, and a preferable image is obtained when β=0.75. Therefore, β is preferably about 0.6 to 0.9.

As another approach for extracting the reflection, a method of turning on and off the lamp in the same scene to take a difference is also conceivable. However, in this different approach, since the presence or absence of light projection with respect to the entire video background changes, the brightness of the entire screen changes. Therefore, it is difficult to distinguish between the presence or absence of reflection and the brightness difference of the background only by taking the difference. On the other hand, according to the method of the present embodiment, it is possible to reliably detect the presence or absence of reflection.

Any combination of the techniques described in Embodiments 1.1 to 1.3, Embodiment 2, Embodiment 3, and Embodiment 4 is effective.

### Application

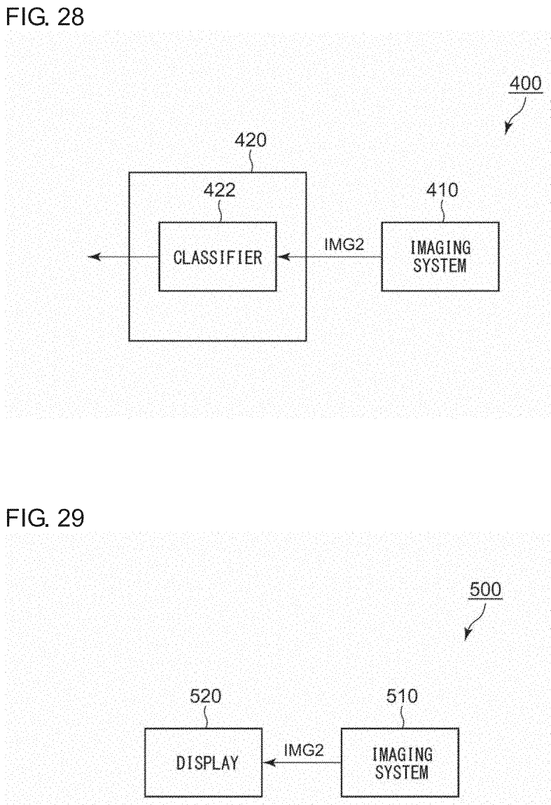

FIG. 28 is a block diagram of an object identification system 400 including an imaging system. The object identification system 400 includes an imaging system 410 and an operation processing apparatus 420. The imaging system 410 is any one of the imaging systems 100, 200, and 300 described in Embodiments 1.1 to 1.3, and generates the image IMG2 in which distortion is corrected.

Alternatively, the imaging system 410 is the imaging system 100 described in Embodiment 2, and generates the image IMG2 in which missing of information due to a foreign object is recovered.

Alternatively, the imaging system 410 is the imaging system 100 described in Embodiment 3, and generates the image IMG2 in which missing of information due to a water droplet is recovered.

Alternatively, the imaging system 410 is the imaging system 100 described in Embodiment 4, and generates the image IMG2 in which reflection is removed.

The operation processing apparatus 420 is structured to identify the position and the type (category, class) of the object on the basis of the image IMG2. The operation processing apparatus 420 may include a classifier 422. The operation processing apparatus 420 can be implemented by a combination of a processor (hardware) such as a central processing unit (CPU), a micro processing unit (MPU), or a microcomputer, and a software program executed by the processor (hardware). The operation processing apparatus 420 may be a combination of a plurality of processors. The operation processing apparatus 420 may be configured only by hardware.

The classifier 422 is implemented on the basis of a prediction model generated by machine learning, and determines a type (category, class) of an object included in an input image. An algorithm of the classifier 422 is not limited, but You Only Look Once (YOLO), Single Shot MultiBox Detector (SSD), Region-based Convolutional Neural Network (R-CNN), Spatial Pyramid Pooling (SPPnet), Faster R-CNN, Deconvolution-SSD (DSSD), Mask R-CNN, or the like can be adopted, or an algorithm developed in the future can be adopted. The operation processing apparatus 420 and the image processing apparatus 120 (220, 320) of the imaging system 410 may be implemented in the same processor.

In the object identification system 400 including the imaging system according to the Embodiments 1.1 to 1.3, the image IMG2 in which the distortion is corrected is input to the classifier 422. Therefore, when learning the classifier 422, an image without distortion can be used as training data. In other words, there is an advantage that it is not necessary to perform learning again even when the distortion characteristic of the imaging system 410 changes.

In the object identification system 400 including the imaging system according to Embodiment 2, the image IMG2 after missing of information due to a foreign object is recovered is input to the classifier 422. Therefore, the identification rate of the object can be increased.

In the object identification system 400 including the imaging system according to Embodiment 3, the image IMG2 after missing of information due to a water droplet is recovered is input to the classifier 422. Therefore, the identification rate of the object can be increased.

In the object identification system 400 including the imaging system according to the Embodiment 4, the image IMG2 in which the reflection is removed is input to the classifier 422. Therefore, the identification rate of the object can be increased.

The output of the object identification system 400 may be used for light distribution control of the vehicle lamp, or may be transmitted to a vehicle-side ECU and used for automatic driving control.

FIG. 29 is a block diagram of a display system 500 including an imaging system. The display system 500 includes an imaging system 510 and a display 520. The imaging system 510 is any one of the imaging systems 100, 200, and 300 according to Embodiments 1.1 to 1.3, and generates the image IMG2 in which distortion is corrected.

Alternatively, the imaging system 510 is the imaging system 100 according to Embodiment 2, and generates the image IMG2 in which missing of information due to a foreign object is recovered.

Alternatively, the imaging system 510 is the imaging system 100 according to Embodiment 3, and generates the image IMG2 in which missing of information due to a water droplet is recovered.

Alternatively, the imaging system 510 is the imaging system 100 according to Embodiment 4, and generates the image IMG2 in which reflection is removed.

The display 520 displays the image IMG2. The display system 500 may be a digital mirror, or may be a front view monitor or a rear view monitor for covering a blind spot.

While the preferred embodiments of the present disclosure have been described using specific terms, such description is for illustrative purposes only, and it is to be understood that changes and variations may be made without departing from the spirit or scope of the appended claims.

### CLAUSES DESCRIBING FEATURES OF THE DISCLOSURE

Clause 10. An imaging system for a vehicle, comprising:

a camera structured to generate a camera image at a predetermined frame rate; and

an image processing apparatus structured to process the camera image,

wherein, when a foreign object is included in a current frame of the camera image, the image processing apparatus searches a past frame for a background image shielded by the foreign object, and attaches the background image to a foreign object region where the foreign object exists in the current frame.

Clause 11. The imaging system according to Clause 10, wherein the image processing apparatus is structured to detect edges for each frame of the camera image, and to set a region surrounded by the edges as a candidate for the foreign object region.

Clause 12. The imaging system according to Clause 11, wherein the image processing apparatus is structured to determine a candidate for the foreign object region as the foreign object region when the candidate remains at substantially an identical position over a predetermined number of frames.

Clause 13. The imaging system according to Clause 10, wherein the image processing apparatus is structured to detect edges for each frame of the camera image, and when edges having an identical shape exist at an identical place of two frames separated by N frames, the image processing apparatus is structured to determine a range surrounded by the edges as the foreign object region.

Clause 14. The imaging system according to Clause 10,

wherein the image processing apparatus is structured:

to define a current reference region in a vicinity of the foreign object region in the current frame;

to detect a past reference region corresponding to the current reference region in the past frame;

to detect offset amounts of the current reference region and the past reference region; and

to set a region obtained by shifting the foreign object region based on the offset amounts in the past frame as the background image.

Clause 15. The imaging system according to Clause 14, wherein detection of the past reference region is based on pattern matching.

Clause 16. The imaging system according to Clause 14, wherein detection of the past reference region is based on an optical flow.

Clause 17. The imaging system according to Clause 10,

wherein the image processing apparatus is structured:

to detect edges for each frame of the camera image, and when edges having an identical shape exist at an identical position of two frames separated by N frames, determines a range surrounded by the edges as the foreign object region;

to define a current reference region in a vicinity of the foreign object region in the current frame of the two frames;

to detect a past reference region corresponding to the current reference region in the past frame of the two frames;

to detect offset amounts of the current reference region and the past reference region; and

to set a region obtained by shifting the foreign object region based on the offset amounts in the past frame as the background image.

Clause 18. The imaging system according to Clause 10, wherein the image processing apparatus is structured to detect the foreign object region by pattern matching.

Clause 19. The imaging system according to Clause 10, wherein the foreign object is a raindrop.

Clause 20. The imaging system according to Clause 10, wherein the camera is built in a lamp and performs imaging via an outer lens.

Clause 21. An image processing apparatus used with a camera and included in an imaging system for a vehicle,

the image processing apparatus structured to, when a foreign object is included in a current frame of a camera image, search a past frame for a background image shielded by the foreign object, and replace a foreign object region where the foreign object exists with the background image.

Clause 22. An imaging system for a vehicle, comprising:

a camera structured to generate a camera image; and

an image processing apparatus structured to process the camera image,

wherein, when a water droplet is shown in the camera image, the image processing apparatus is structured to perform operation of a lens characteristic of the water droplet and to correct an image in a region of the water droplet based on the lens characteristic.

Clause 23. The imaging system according to Clause 22, wherein the image processing apparatus is structured to set a predetermined region of the camera image as an image correction target.

Clause 24. The imaging system according to Clause 22, wherein the image processing apparatus is structured to detect edges for each frame of the camera image, and to set a region surrounded by the edges as a candidate for the water droplet.

Clause 25. The imaging system according to Clause 24, wherein the image processing apparatus is structured to determine a candidate for the water droplet as the water droplet when the candidate remains at substantially an identical position over a predetermined number of frames.

Clause 26. The imaging system according to Clause 22, wherein the image processing apparatus is structured to detect edges for each frame of the camera image, and when edges having an identical shape exist at an identical place of two frames separated by N frames, the image processing apparatus is structured to determine a range surrounded by the edges as the water droplet.

Clause 27. The imaging system according to Clause 22, wherein the image processing apparatus is structured to detect the water droplet by pattern matching.

Clause 28. The imaging system according to Clause 22, wherein the camera is built in a lamp and performs imaging via an outer lens.

Clause 29. An image processing apparatus used with a camera and included in an imaging system for a vehicle,

wherein the image processing apparatus is structured, when a water droplet is shown in a camera image generated by the camera, to perform operation of a lens characteristic of the water droplet and to correct an image in a region of the water droplet based on the lens characteristic.

Clause 30. An imaging system for a vehicle, comprising:

a camera that is built in a vehicle lamp together with a lamp light source and generates a camera image at a predetermined frame rate; and

an image processing apparatus structured to process the camera image,

wherein the image processing apparatus is structured to extract a reflection component of emitted light of the lamp light source based on a plurality of frames, and to remove the reflection component from a current frame.

Clause 31. The imaging system according to Clause 30, wherein the image processing apparatus is structured to extract a bright portion commonly appearing in the plurality of frames as the reflection component.

Clause 32. The imaging system according to Clause 30, wherein the image processing apparatus is structured to generate the reflection component by taking a logical product of each pixel of the plurality of frames.

Clause 33. The imaging system according to Clause 30, wherein the plurality of frames are separated by at least three seconds or more.

Clause 34. The imaging system according to Clause 30, wherein the image processing apparatus is structured to exclude a predetermined exclusion region determined from a positional relationship between the lamp light source and the camera from reflection component extraction processing.

Clause 35. The imaging system according to Clause 30, wherein the plurality of frames are two frames.

Clause 36. The imaging system according to Clause 30, wherein the plurality of frames are imaged in a dark scene.

Clause 37. A vehicle lamp comprising: a lamp; and

the imaging system according to Clause 30.

Clause 38. An image processing apparatus used with a camera and included in an imaging system for a vehicle,

wherein the camera is built in a vehicle lamp together with a lamp light source, and

the image processing apparatus is structured to extract a reflection component of emitted light of the lamp light source based on a plurality of frames of a camera image generated by the camera, and to remove the reflection component from a current frame.

What is claimed is:

1. An imaging system for a vehicle, comprising:
a camera; and
an image processing apparatus structured to process an output image by the camera,
wherein the image processing apparatus is structured to track an object image included in the output image, to generate information for correcting distortion of the output image based on a change in shape accompanying movement of the object image, and to correct the output image using the information.

2. The imaging system according to claim 1, wherein a reference region with small distortion is defined in the output image, and a shape where the object image is included in the reference region is set to a true shape of the object image.

3. The imaging system according to claim 2, wherein the camera is disposed such that a vanishing point is included in the reference region.

4. The imaging system according to claim 1, wherein the image processing apparatus is structured to detect an image of a reference object whose true shape is known from the output image, and to generate information for correcting distortion of the output image based on the true shape and a shape of the image of the reference object in the output image.

5. The imaging system according to claim 4, wherein the object image whose true shape is known includes a traffic sign.

6. An imaging system for a vehicle, comprising:
a camera; and
an image processing apparatus structured to process an output image by the camera,
wherein the image processing apparatus is structured to detect an image of a reference object whose true shape is known from the output image, to generate information for correcting distortion of the output image based on the true shape and a shape of the image of the reference object in the output image, and to correct the output image using the information.

7. The imaging system according to claim 1, wherein the camera is built in a lamp and performs imaging via an outer lens.

8. An image processing apparatus used with a camera and included in an imaging system for a vehicle,
the image processing apparatus structured to track an object image included in the output image by the camera, to generate information for correcting distortion of the output image based on a change in shape accompanying movement of the object image, and to correct the output image using the information.

9. An image processing apparatus used with a camera and included in an imaging system for a vehicle,
the image processing apparatus structured to detect an image of an object whose true shape is known from the output image by the camera, to generate information for correcting distortion of the output image based on the true shape and a shape of the image of the object in the output image, and to correct the output image using the information.
